(19) United States
(12) Patent Application Publication
(10) Pub. No.: US 2024/0187928 A1
(43) Pub. Date: Jun. 6, 2024

(54) METHOD AND APPARATUS FOR UP ENHANCEMENT

(71) Applicant: Apple Inc., Cupertino, CA (US)

(72) Inventors: Fangli Xu, Beijing (CN); Alexander Sirotkin, Tel Aviv (IL); Dawei Zhang, Saratoga, CA (US); Haijing Hu, Los Gatos, CA (US); Naveen Kumar R. Palle Venkata, San Diego, CA (US); Pavan Nuggehalli, San Carlos, CA (US); Ralf Rossbach, Munich (DE); Sarma V. Vangala, Campbell, CA (US); Sethuraman Gurumoorthy, San Ramon, CA (US); Weidong Yang, San Diego, CA (US); Yuqin Chen, Beijing (CN); Zhibin Wu, Los Altos, CA (US)

(73) Assignee: Apple Inc., Cupertino, CA (US)

(21) Appl. No.: 17/796,635

(22) PCT Filed: Sep. 3, 2021
(86) PCT No.: PCT/CN2021/116556

§ 371 Date: Jul. 29, 2022

(51) Int. Cl. H04W 28/06

(52) U.S. Cl. CPC H04W 28/065

(57) ABSTRACT

Provided is a method for a user equipment (UE), comprising: acquiring configuration information including a first configuration information for determining a configured grant (CG)/semi-persistent scheduling (SPS) configuration, the first configuration information is included in a radio resource control (RRC) message; and performing a data transmission/reception via the CG/SPS configuration determined by the configuration information.

### TECHNICAL FIELD

This application relates generally to wireless communication systems, and more specifically to a method and an apparatus for user plane (UP) enhancement.

### BACKGROUND

Wireless mobile communication technology uses various standards and protocols to transmit data between a base station and a wireless mobile device. Wireless communication system standards and protocols can include, but not limited to, the 3rd Generation Partnership Project (3GPP) long term evolution (LTE): fifth-generation (5G) 3GPP new radio (NR) standard; technologies beyond 5G. In fifth generation (5G) wireless radio access networks (RANs), the based station may include an RAN Node such as a 5G Node, new radio (NR) node or g Node B (gNB), which communicate with a wireless communication device, also known as user equipment (UE).

In the UP configuration, the configured grant (CG)/semi-persistent scheduling (SPS) is normally applied for the low latency service's scheduling and designed for the service with small packet size. Besides, the CG/SPS configuration is configured per cell with a fix periodicity and the CG/SPS activation/deactivation is per CG/SPS configuration, one packet size per bandwidth part (BWP).

### SUMMARY

According to an aspect of the present disclosure, a method for a user equipment (UE) is provided that comprises acquiring configuration information including a first configuration information for determining a configured grant (CG)/semi-persistent scheduling (SPS) configuration, wherein the first configuration information is included in a radio resource control (RRC) message; and performing a data transmission/reception via the CG/SPS configuration determined by the configuration information.

According to an aspect of the present disclosure, a method for a user equipment (UE) is provided that comprises acquiring, packet association information, by an access stratum (AS) layer from an upper layer above the AS layer, wherein the packet association information indicates packets that are associated together to correspond to the same frame and a critical packet among the packets; and performing a data transmission via dedicated scheduling for the critical packet.

According to an aspect of the present disclosure, an apparatus for a user equipment (UE) is provided that comprising one or more processors configured to perform steps of the method as describe above.

According to an aspect of the present disclosure, a computer readable medium having computer programs stored thereon is provided, which, when executed by one or more processors, cause an apparatus to perform steps of the method as describe above.

According to an aspect of the present disclosure, an apparatus for a communication device is provided that comprises means for performing steps of the method as describe above.

According to an aspect of the present disclosure, a computer program product comprising computer programs which, when executed by one or more processors, cause an apparatus to perform steps of the method as describe above.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station and a user equipment (UE) in accordance with some embodiments.

FIG. 2 illustrates a flowchart for an exemplary method for a UE in accordance with some embodiments.

FIG. 3 illustrates a schematic diagram for an exemplary method for a UE in accordance with some embodiments.

FIGS. 4A-4B illustrate schematic diagrams for exemplary methods for a UE in accordance with some embodiments.

FIG. 5 illustrates a schematic diagram for an exemplary method for a UE in accordance with some embodiments.

FIG. 6 illustrates a schematic diagram for an exemplary method for a UE in accordance with some embodiments.

FIG. 7 illustrates a flowchart for an exemplary method for a UE in accordance with some embodiments.

FIG. 8 illustrates a flowchart for an exemplary method for a UE in accordance with some embodiments.

FIG. 9 illustrates a schematic diagram for an exemplary method for a UE in accordance with some embodiments.

FIG. 10 illustrates a schematic diagram for an exemplary method for a UE in accordance with some embodiments.

FIG. 11A-11C illustrate schematic diagrams for exemplary methods for a UE in accordance with some embodiments.

FIG. 12 illustrates a flowchart for an exemplary method for a UE in accordance with some embodiments.

FIG. 13 illustrates a communication device (e.g., a UE or a base station) in accordance with some embodiments.

FIG. 14 illustrates exemplary interfaces of baseband circuitry in accordance with some embodiments.

FIG. 15 illustrates components in accordance with some embodiments.

FIG. 16 illustrates an architecture of a wireless network in accordance with some embodiments.

### DETAILED DESCRIPTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an CNB, an RNC and/or a gNB, such devices may be replaced with any type of base station.

In the related art, data traffic that requires low latency with high data rate, high reliability, flexible periodicity, low frame error rate, and frame level integration and the like is drawing wide attentions. An example of such data traffic may be the extended reality (XR) traffic. An efficient data transmission/reception mechanism is required to improve the performance for such data traffic.

Aiming to this, it is provided by the present disclosure a method and an apparatus for the user plane (UP) enhancement. Various aspects of the present disclosure will be described below in conjunction with the accompanying drawings.

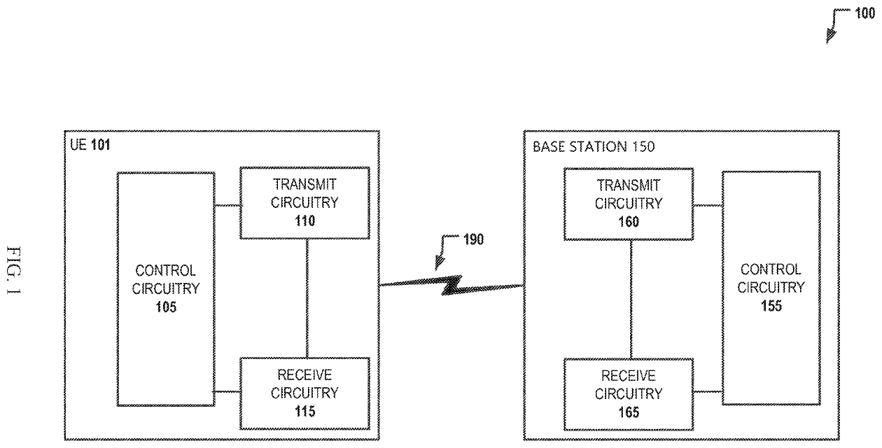

FIG. 1 is a block diagram of a system including a base station and a user equipment (UE) in accordance with some embodiments. FIG. 1 illustrates a wireless network 100, in accordance with some embodiments. The wireless network 100 includes a UE 101 and a base station 150 connected via an air interface 190.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120 degree area with an array of antennas directed to each sector to provide 360 degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with MTC. In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuitry 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g. messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person to person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is comprised of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is comprised of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

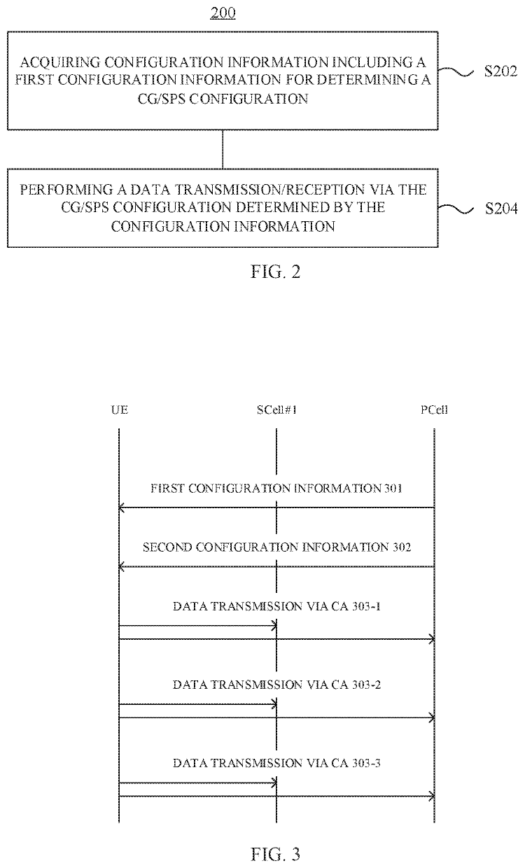

FIG. 2 illustrates a flowchart for an exemplary method for a UE in accordance with some embodiments.

As shown in FIG. 2, the method for a UE may comprise the following steps: S202, acquiring configuration information including a first configuration information for determining a configured grant (CG)/semi-persistent scheduling (SPS) configuration; and S204, performing a data transmission/reception via the CG/SPS configuration determined by the configuration information. The first configuration information may be included in a radio resource control (RRC) message. For example, the network (NW) side may configure and active the CG/SPS via the RRC signaling.

In some embodiment, the configuration information may further include a second configuration information for determining a CG/SPS configuration. The second configuration information may be included in downlink control information (DCI).

In some embodiment, in the first time, the second configuration information may be provided with the first configuration information via the RRC message. For example, the second configuration may be provided together with the first configuration from the gNB via the RRC message.

In some embodiment, the UE may be the UE 101 as described in FIG. 1. The UE may acquire the configuration information, which includes the first configuration information and the second configuration information, from the network side, e.g., from a primary serving cell, i.e., PCell.

The data transmission/reception via the CG/SPS configuration may be performed at a given occasion, which means the UE can deliver the uplink (UL) transmission or monitor to receive downlink (DL) at the occasion via the CG configuration and the SPS configuration, respectively.

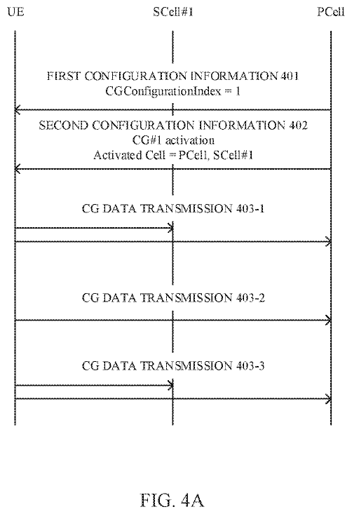

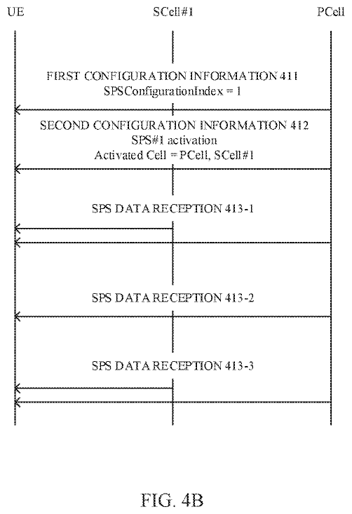

In some embodiments, one CG/SPS configuration may be applicable on multiple serving cells, e.g., a PCell and at least one secondary serving cells. i.e., SCells. The data transmission/reception may be performed on multiple serving cells via carrier aggregation (CA). The active serving cells for the CG/SPS configuration may be indicated from the network side, e.g., PCell. Further details will be described below in reference to FIG. 3 and FIGS. 4A-4B.

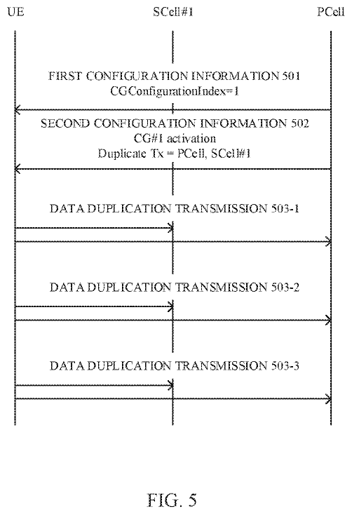

In some embodiments, the CG/SPS configuration may be performed in a duplication manner, in which a bundle of occasions is configured on specific servings cell indicated in the configuration information. Further details will be described below in reference to FIG. 5.

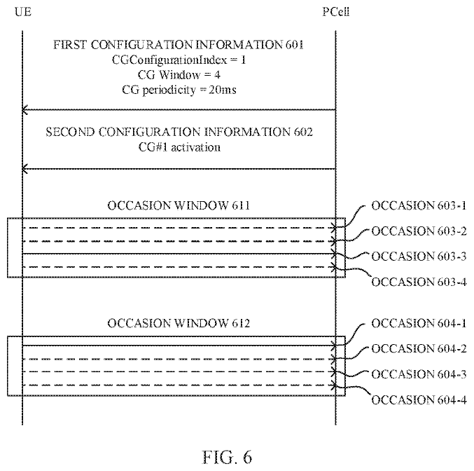

In some embodiments, an occasion window, which including numbers of selectable occasions, may be indicated by the configuration information. The data transmission/reception may be performed at an occasion within the occasion window. Further details will be described below in reference FIG. 6.

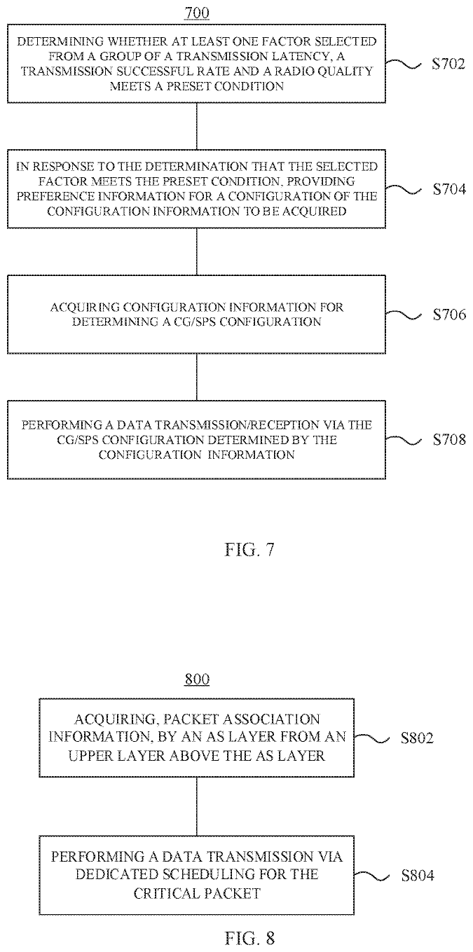

In some embodiments, in the case that a trigger factor, such as a transmission latency, a transmission successful rate and a radio quality meets a preset condition, the UE may initiate the acquiring of the configuration information (e.g., S202 in FIG. 2) and thus the subsequent data transmission/reception may be performed as above described. Further details will be described below in reference FIG. 7.

Hereinafter, for purpose of illustration, FIGS. 3-6 will be described in connection with the embodiment in which the second configuration information is further provided and included in the DCI.

FIG. 3 illustrates a schematic diagram for an exemplary method for a UE in accordance with some embodiments.

As shown in FIG. 3, the UE may acquire the first configuration information 301 indicating a parameter of a CG/SPS configuration index having a predetermined value. The UE may also acquire the second configuration information 302 indicating an occasion for the CG/SPS configuration and a plurality of serving cells on which the CG/SPS configuration is applied. Further, the UE may perform the data transmission/reception on the plurality of serving cells via CA at the occasion for the CG/SPS configuration. FIG. 3 shows three data transmission 303-1 to 303-3 for the purpose of illustration. Nevertheless, less or more data transmission is possible based on the actual applications. Besides, the case of the data reception is similar to the case of the data transmission.

The first configuration information via RRC message may be represented by CGConfigurationIndex=1, which indicates a CG configuration. Similarly, the first configuration information via RRC message may include SPSConfigurationIndex=1, which indicates a SPS configuration.

Furthermore, the second configuration information via DCI may include layer 1 (L1) CG activation command, such as CG #1 activation. The CG grant may be applied as CG occasions based on the L1 CG activation command. The second configuration information may include parameters indicating the serving cells that applies the CG grant. For example, a parameter Activated Cell=PCell, SCell #1 indicates to apply a same CG grant on both PCell and SCell #1. FIG. 3 shows SCell #1 for the purpose of illustration, but more SCells may be possible based on the actual implementation.

With such a first and second configuration information, the UE may initiate the data transmission via CA on PCell and SCell #1.

Similarly, the second configuration information via DCI may include L1 SPS activation command. The SPS grant may be applied as an SPS occasion based on the L1 SPS activation command. The second configuration information may include parameters indicating the serving cells that applies the SPS grant. For example, a parameter Activated Cell=PCell. SCell #1 indicates to apply a same SPS grant on both PCell and SCell #1.

With such a first and second configuration information, the UE may initiate the data reception via CA on PCell and SCell #1.

As shown in FIG. 3, the occasions used to perform the data transmission/reception on the plurality of serving cells via CA may be multiple, e.g., 303-1 to 303-3 as shown in FIG. 3.

According to the present disclosure, data transmission/reception is performed via CA with a plurality of serving cells simultaneously. Therefore, the total data transmission/reception rate can be increased with more serving cells involved, which can support the transmission with high data rate for scheduling of low latency service.

FIGS. 4A-4B illustrate schematic diagrams for exemplary methods for a UE in accordance with some embodiments.

As shown in FIG. 4A, the UE may acquire the first configuration information 401 indicating CGConfigurationIndex=1. The UE may also acquire the second configuration information 402 indicating CG #1 activation and Activated Cell=PCell, SCell #1. Further, the UE may perform the CG data transmission 403-1 to 403-3 based on the first and second configuration information.

In some embodiments, the UE may determine whether any of the plurality of serving cells is sufficient for the data transmission based on data amount. For example, if neither of the serving cells PCell and SCell #1 can be sufficient for the data transmission, the UE may perform the CG data transmission 403-1 and 403-3 on both PCell and SCell #1. Alternatively, if the UE determines the data amount in the second data transmission 403-2 is small such that one serving cell in the active serving cells is sufficient for data transmission, UE may transmit data on the one serving cell (e.g., PCell in FIG. 4A) in response to such a determination.

The serving cell selection scheme can be configured by the network side (e.g., PCell) or based on UE implementation.

According to the present disclosure, the serving cell selection scheme can avoid the unnecessary transmission on other serving cells via CA and potential resource wastes.

As shown in FIG. 4B, the UE may acquire the first configuration information 411 indicating SPSConfigurationIndex=1. The UE may also acquire the second configuration information 412 indicating SPS #1 activation and Activated Cell=PCell, SCell #1. Further, based on the configuration information, the occasions for the data reception may be determined. The UE may perform the SPS data reception 413-1 to 413-3 based on the first and second configuration information.

In some embodiments, in response to detecting discontinuous transmission (DTX) occurs on the second data transmission (i.e., 413-2 as shown in FIG. 4B) on SCell #1, the UE may consider the corresponding secondary serving cell, i.e., SCell #1, does not transmit data at this occasion, and skip the data reception on SCell #1 to only perform data reception on the a selected active cell (e.g., PCell as shown in FIG. 4). The selection of the serving cell for data reception may be based on the capability of the UE or the UE implementation. Thus, any active cell may be selected beside the primary cell.

FIG. 5 illustrates a schematic diagram for an exemplary method for a UE in accordance with some embodiments.

As shown in FIG. 5, the UE may acquire the first configuration information 501 indicating a CGConfigurationIndex=1. The UE may also acquire the second configuration information 502 indicating CG #1 activation and Duplicate Tx=PCell. SCell #1. Further, the UE may perform, e.g., the CG grant duplication transmission 503-1 to 503-3 on the PCell and SCell #1 via the bundle of occasions.

In some embodiments, the bundle of occasions on different serving cells may be configured by the network side (e.g., PCell as shown in FIG. 5). In response to being activated by the network side, the bundle of occasions is used for duplication transmission on multiple serving cells, with one occasion per serving cell. Therefore, the data transmission/reception may be performed simultaneously on a primary cell (e.g., PCell as shown in FIG. 5) among the plurality of serving cells and a secondary cell (e.g., SCell #1 as shown in FIG. 5) among the plurality of serving cells.

Similarly, SPS configuration may be indicated in the first configuration information. The second configuration information may provide L1 activation command and indicate the serving cells for SPS data reception correspondingly.

Furthermore, with a same CG grant applied on both primary serving cell (e.g., PCell as shown in FIG. 5) and secondary serving cell (e.g., SCell #1 as shown in FIG. 5), a predetermined parameter can be used to indicate the transmission method. For example, PCell can be determined for first transmission with RV index=0, and SCell #1 can be determined for retransmission with RV index=2.

The retransmission (or duplicated transmission) may be a full copy of the first transmission (or new transmission), i.e., the retransmission delivers exactly the same data as the first transmission.

According to the present disclosure, the data duplication transmission performed via multiple serving cells can ensure a high reliability in the transmission.

FIG. 6 illustrates a schematic diagram for an exemplary method for a UE in accordance with some embodiments.

As shown in FIG. 6, the UE may acquire the first configuration information 601 indicating CGConfigurationIndex=1, CG Window=4, and CG periodicity=20 ms. The UE may also acquire the second configuration information 602 indicating CG #1 activation. Further, the UE may perform the CG grant transmission on PCell via one of occasions (e.g., 603-3 or 604-1 as shown in FIG. 6) in each of occasion windows 611 and 612. Other dash arrow lines as shown in FIG. 6 (i.e., 603-1, 603-2, 603-4, 604-2, 604-3 and 604-4) refer to other selectable occasions within the occasion windows 611 and 612. Although four selectable occasions within an occasion window and two occasion windows having a periodicity of 20 ms are shown in FIG. 6, they are not limited to the above examples based on the actual implementation.

The occasion window per period for transmission can be applied not only in the CG configuration but also in the SPS configuration. For example, in the CG configuration, the UE may process the UL transmission at a selected occasion within the occasion window. For another example, in the SPS configuration, the UE may keep monitoring until the physical downlink shared channel (PDSCH) reception starts at a selected occasion within the occasion window.

In some embodiments, the first configuration information may include a second parameter (i.e., CG window=4) indicating an occasion window having a predetermined number of selectable occasions. For example, as shown in FIG. 6, the occasion windows 611 and 612 may have selectable occasions 603-1 to 603-4 and 604-1 to 604-4, respectively. As described above, the number of the selectable occasions is not limited to four, which is merely an example for implementation.

Since the CG grant is applied as one CG occasion, the UE may be allowed for transmission once per window. The occasion for transmission within the occasion window may be selected based on UE implementation or the data status (e.g., the time when the data is arrival for transmission).

In some embodiments, the first configuration information may further include a third parameter indicating an occasion window per periodicity (e.g., CG periodicity=20 ms as shown in FIG. 6). Accordingly, the occasion window and position within each periodicity may be determined. It is noted that the periodicity is referred to in terms of the occasion windows. It means the selected occasions in different occasion windows may be independent from each other. For example, as shown in FIG. 6, the selection of occasion in the occasion window 611 may not affect the selection of occasion in the occasion window 612.

According to the present disclosure, a flexible timing for data transmission/reception can be obtained by applying the occasion windows. For example, as shown in FIG. 6, if the data is not ready for transmission at the first occasion 603-1 within the first occasion window 611, there may be still remaining occasions within the first occasion window to be used. Without the occasion window, the data has to wait until the next occasion (e.g., the occasion 604-1 as shown in FIG. 6) for transmission, which increase the latency of the data transmission.

FIG. 7 illustrates a flowchart for an exemplary method for a UE in accordance with some embodiments.

As shown in FIG. 7, the method for a UE may comprise the following steps: S702, determining whether at least one factor selected from a group of a transmission latency, a transmission successful rate and a radio quality meets a preset condition; S704, in response to the determination that the selected factor meets the preset condition, providing preference information for a configuration of the configuration information to be acquired: S706, acquiring an configuration information for determining a configured grant (CG)/semi-persistent scheduling (SPS) configuration; and S708, performing a data transmission/reception via the CG/SPS configuration determined by the configuration information.

For example, when the radio quality is lower than a predetermined threshold, the duplication transmission may be triggered and thus the configuration information having duplication transmission indications, such as Duplicate Tx=PCell, SCell #1 as shown in FIG. 5, may be acquired from the network side. Alternatively or additionally, the transmission via CA can be triggered to reduce modulation and coding scheme (MCS) for the transmission in each cell, and thus the configuration information having CA indications, such as Activated Cell=PCell, SCell #1 as shown in FIGS. 4A and 4B may be acquired from the network side. The radio quality may also be considered by the network side in the cell selection scheme to select the activated cell for transmission.

Furthermore, when transmission latency is larger than a predetermined threshold, the above transmission via CA, duplication transmission, and occasion window may be triggered by acquiring the configuration information having corresponding indications from the network side.

Additionally, when the transmission success rate is lower than a predetermined threshold, the transmission via CA or the duplication transmission may be triggered and thus the configuration information having corresponding indications from the network side may be acquired. The transmission success rate may also be considered by the network side in the cell selection scheme to select the activated cell for transmission.

The evaluation of the triggering factors, such as the transmission latency, the transmission successful rate and the radio quality, is performed at the network side based on network implementation. After the evaluation, the network side may configure the configuration information including corresponding indications and send it to UE.

Alternatively, the evaluation of the triggering factors, such as the transmission latency, the transmission successful rate and the radio quality, may be performed at UE. After the evaluation. UE may transmit the preference or suggestion, which is generated based on the evaluation, via the L1/L2/L3 signaling to the network side. The network side may configure the configuration information including corresponding indications and send it to UE.

FIG. 8 illustrates a flowchart for an exemplary method for a UE in accordance with some embodiments.

As shown in FIG. 8, the method for the UE may comprise the following steps: S802, acquiring, packet association information, by an access stratum (AS) layer from an upper layer above the AS layer; and S804, performing a data transmission via dedicated scheduling for the critical packet. The packet association information indicates packets that are associated together to correspond to the same frame and a critical packet among the packets.

At least one remaining packet corresponding to the same frame with the critical packet may depend on the critical packet. In such a case, if the transmission/reception of the critical packet is unsuccessful, the remaining packet is no longer useful.

According to the present disclosure, the frame level integrated transmission can be achieved so that the quality of service (QOS) mechanism can consider frame level parameters, e.g., the frame error rate, the frame delay budget etc. The frame level integrated transmission for identifying which packets belonging to one video frame is also beneficial for satisfying the XR service requirement.

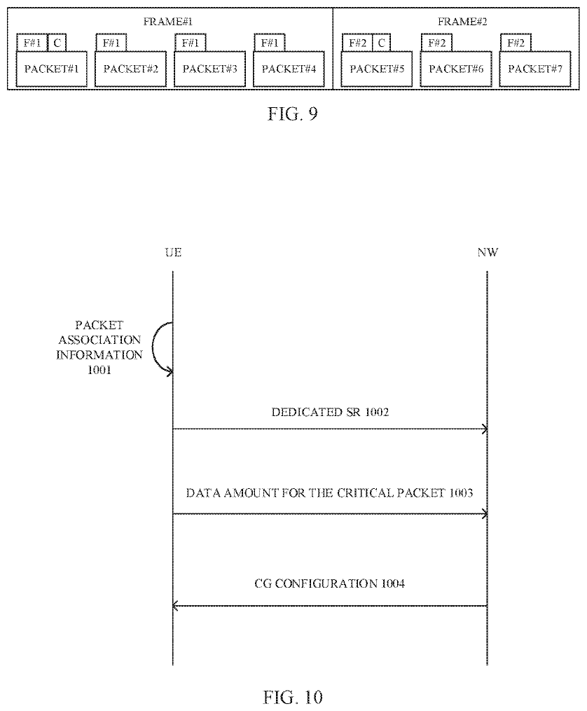

FIG. 9 illustrates a schematic diagram for an exemplary method for a UE in accordance with some embodiments.

The packet association information may indicate the packets that are associated together to correspond to the same frame by marking the same flag for the packets corresponding to the same frame.

As shown in FIG. 9, packets PACKET #1 to PACKET #4 may have a same flag F #1, which indicates the packets PACKET #1 to PACKET #4 are associated together to a frame FRAME #1. Further, packets PACKET #5 to PACKET #7 may have a same flag F #2, which indicates the packets PACKET #5 to PACKET #7 are associated together to a frame FRAME #2.

The packet association information may also indicate the critical packet among the packets by marking the critical flag on the critical packet. Thus, a flag C may be marked on e.g., the PACKET #1 and PACKET #5, which are the critical packets in the frames FRAME #1 and FRAME #2, respectively.

The flags may be marked for the packets by the upper layer and delivered to the AS laver. The AS layer may identify the packet association information via these flags, and perform data transmission correspondingly.

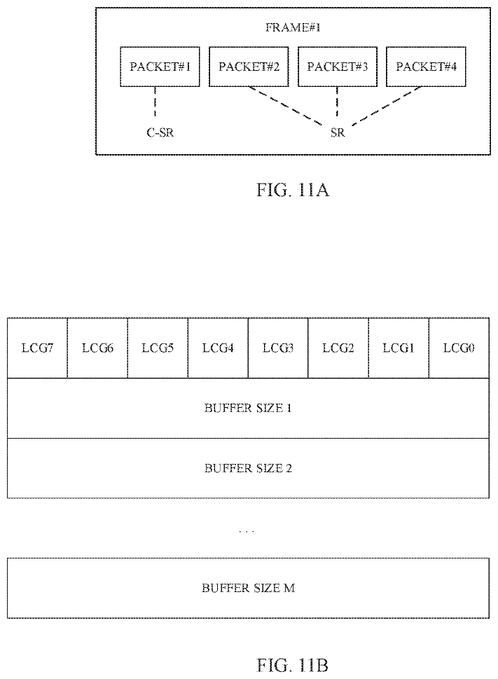

FIG. 10 illustrates a schematic diagram for an exemplary method for a UE in accordance with some embodiments. As shown in FIG. 10, with the packet association information 1001 acquired from the upper layer, a scheduling scheme for the transmission of high reliability packet (i.e., the critical packet) is performed.

In some embodiments, the UE may provide a dedicated scheduling request (SR) 1002 to the network side (NW) to request the dedicated scheduling for the critical packet. The UE may also provide a data amount for the critical packet 1003 in a buffer status report (BSR) of a medium access control (MAC) control element (CE) to the NW. Additionally, the UE may acquire a configured grant (CG) configuration 1004 from the NW indicating a higher priority for the critical packet than the remaining packet among the packets. Further details will be described below in reference to FIGS. 11A-11C.

FIG. 11A-11C illustrate schematic diagrams for exemplary methods for a UE in accordance with some embodiments.

As shown in FIG. 11A, packets PACKET #1, PACKET #2, PACKET #3 and PACKET #4 may correspond to a frame FRAME #1. Upon the arrival of the critical packet, the UE may provide a special SR (e.g., C-SR as shown in FIG. 11A) for the critical packet (e.g., PACKET #1 as shown in FIG. 11A), which requests a reliable scheduling from the NW. Further, the UE may provide the normal SR for the remaining packets PACKET #2, PACKET #3 and PACKET #4. The NW may configure a special resource for the critical packet, and associate it with one or more special logic channels (LCH). Although four packets are shown in FIG. 11A, less or more packets are possible based on the actual implementation.

As shown in FIG. 11B, the UE may provide a data amount for the critical packet in a BSR of a MAC CE. A special logic channel group (LCG), e.g., LCG1 that corresponding to a buffer size BUFFER SIZE 1, may be configured by the NW for the critical packet transmission based on the buffer information in various LCGs. Then, the UE may perform the transmission for critical packet first with the special LCG configured by the NW.

As shown in FIG. 11C, the UE may acquire a DCI indicating a higher priority for the critical packet than the remaining packet among the packets. The DCI may be provided from the NW. Upon receipt of the DCI, the corresponding grant is only used for the critical packet (i.e., the packet PACKET #1 in the FRAME #1) transmission as the priority indicated in the DCI. Thus, only the packet PACKET #1 shown in FIG. 11C is transmitted by this grant (as indicated though the dash line).

In other words, the NW may configure the high L1 priority or critical specific priority for the critical packet transmission. The UE may first check the LCH associated with this CG/DG. If the critical priority is set for the LCH, the grant of this CG/DG configuration may just be allowed to deliver the critical packet of those LCHs directly.

According to the present disclosure, the special resource configured for the critical packet with higher reliability and priority, and the frame level performance can also be improved accordingly.

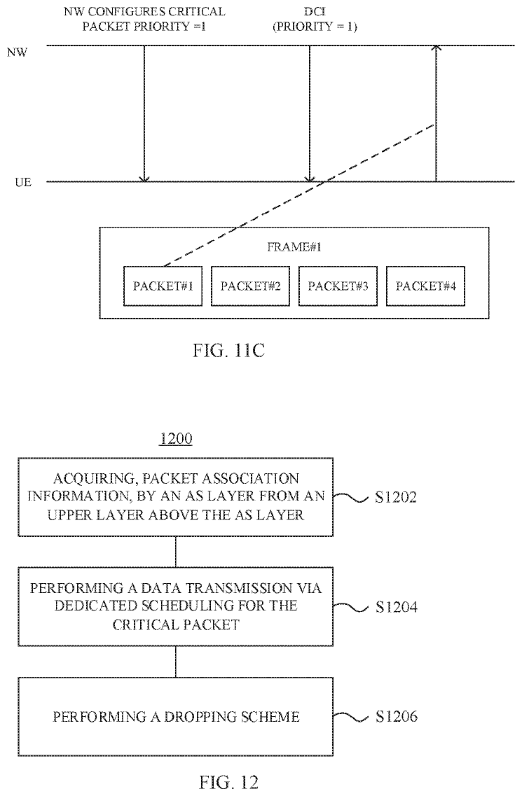

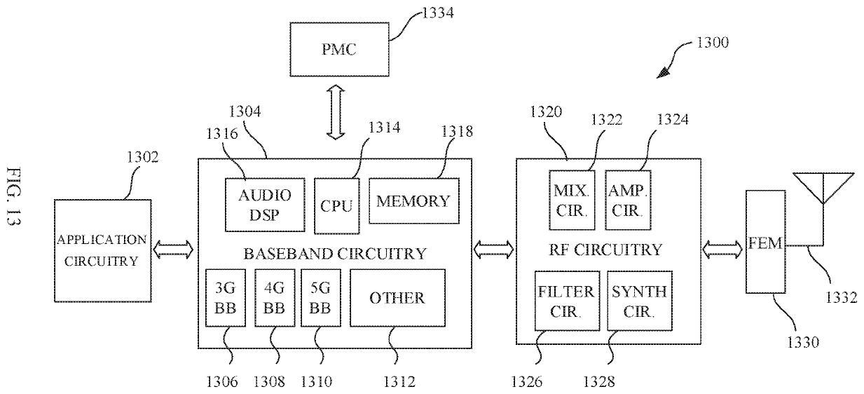

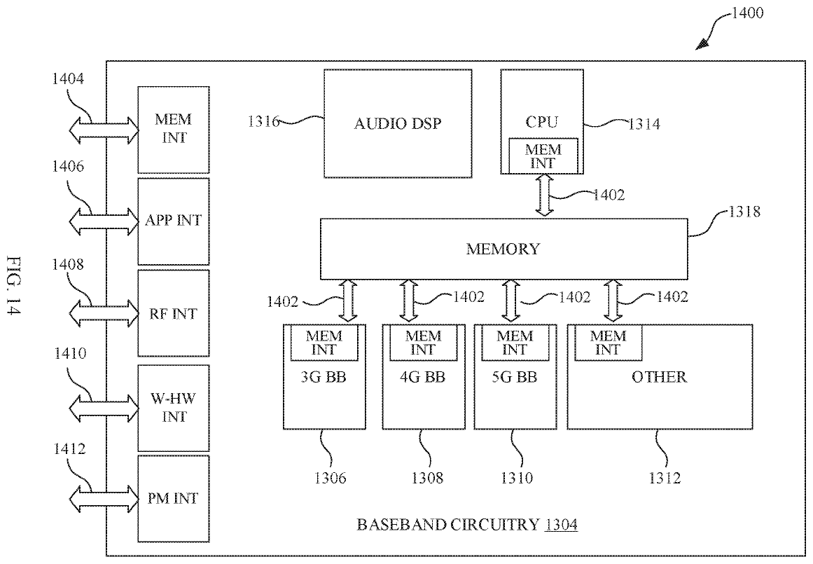

FIG. 12 illustrates a flowchart for an exemplary method for a UE in accordance with some embodiments.

As shown in FIG. 12, the method for the UE may comprise the following steps: S1202, acquiring, packet association information, by an access stratum (AS) layer from an upper layer above the AS layer; S1204, performing a data transmission via dedicated scheduling for the critical packet; and S1206, performing a dropping scheme.

In some embodiments, performing a dropping scheme may determine whether the data transmission for the critical packet is successfully performed. As described above, if the transmission of the critical packet is unsuccessful, the at least one remaining packet corresponding to the same frame may no longer be useful. Thus, in response to the determination that the data transmission for the critical packet is not successfully performed, the data transmission for the remaining packet that has not been transmitted may become unnecessary and may be discarded.

In some embodiments, in an acknowledge mode (AM mode), directly dropping the packet may result in the mismatch in serial number (SN) or other automatic repeat request (ARQ) errors. Therefore, if the remaining packet has been allocated with the SN or is under an ongoing transmission, the UE may continue to perform the data transmission in a manner that the remaining packet is indicated in a radio link control (RLC) header only without any payload for transmission. The transmission of packet indicated in a RLC header can keep ARQ running correctly.

In some embodiments, as to the date reception (i.e., in the DL direction), the UE may receive the packets that are associated together to correspond to a same frame. In this case, the associated information may be carried in the packet and acquired by the UE.

Furthermore, the UE may determine whether the critical packet among the packets is successfully received. In response to the determination that the critical packet is not successfully received, UE may drop the remaining packet at the AS layer without transmitting them to the upper layer.

In some embodiments, the UE may also provide a RLC acknowledgement (ACK) for the remaining packet as a feedback for the reception while dropping the remaining packet. The feedback may keep ARQ running correctly for AM mode.

According to the present disclosure, the packet dropping scheme performed by UE may reduce the unnecessary data transmission/reception after determining the critical packet is not transmitted/received successfully. Furthermore, the dropping scheme may also keep the ACK or error detection mechanism running correctly.

FIG. 13 illustrates example components of a device 1300 in accordance with some embodiments. In some embodiments, the device 1300 may include application circuitry 1302, baseband circuitry 1304, Radio Frequency (RF) circuitry (shown as RF circuitry 1320), front-end module (FEM) circuitry (shown as FEM circuitry 1330), one or more antennas 1332, and power management circuitry (PMC) (shown as PMC 1334) coupled together at least as shown. The components of the illustrated device 1300 may be included in a UE or a RAN node. In some embodiments, the device 1300 may include fewer elements (e.g., a RAN node may not utilize application circuitry 1302, and instead include a processor/controller to process IP data received from an EPC). In some embodiments, the device 1300 may include additional elements such as, for example, memory/storage, display, camera, sensor, or input/output (I/O)) interface. In other embodiments, the components described below may be included in more than one device (e.g., said circuitries may be separately included in more than one device for Cloud-RAN (C-RAN) implementations).

The application circuitry 1302 may include one or more application processors. For example, the application circuitry 1302 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1300. In some embodiments, processors of application circuitry 1302 may process IP data packets received from an EPC.

The baseband circuitry 1304 may include circuitry such as, but not limited to, one or more single-core or multi-core processors. The baseband circuitry 1304 may include one or more baseband processors or control logic to process baseband signals received from a receive signal path of the RF circuitry 1320 and to generate baseband signals for a transmit signal path of the RF circuitry 1320. The baseband circuitry 1304 may interface with the application circuitry 1302 for generation and processing of the baseband signals and for controlling operations of the RF circuitry 1320. For example, in some embodiments, the baseband circuitry 1304 may include a third generation (3G) baseband processor (3G baseband processor 1306), a fourth generation (4G) baseband processor (4G baseband processor 1308), a fifth generation (5G) baseband processor (5G baseband processor 1310), or other baseband processor(s) 1312 for other existing generations, generations in development or to be developed in the future (e.g., second generation (2G), sixth generation (6G), etc.). The baseband circuitry 1304 (e.g., one or more of baseband processors) may handle various radio control functions that enable communication with one or more radio networks via the RF circuitry 1320. In other embodiments, some or all of the functionality of the illustrated baseband processors may be included in modules stored in the memory 1318 and executed via a Central Processing Unit (CPET 1314). The radio control functions may include, but are not limited to, signal modulation/demodulation, encoding/decoding, radio frequency shifting, etc. In some embodiments, modulation/demodulation circuitry of the baseband circuitry 1304 may include Fast-Fourier Transform (FFT), precoding, or constellation mapping/demapping functionality. In some embodiments, encoding/decoding circuitry of the baseband circuitry 1304 may include convolution, tail-biting convolution, turbo. Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1304 may include a digital signal processor (DSP), such as one or more audio DSP(s) 1316. The one or more audio DSP(s) 1316 may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1304 and the application circuitry 1302 may be implemented together such as, for example, on a system on a chip (SOC).

In some embodiments, the baseband circuitry 1304 may provide for communication compatible with one or more radio technologies. For example, in some embodiments, the baseband circuitry 1304 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 1304 is configured to support radio communications of more than one wireless protocol may be referred to as multi-mode baseband circuitry.

The RF circuitry 1320 may enable communication with wireless networks using modulated electromagnetic radiation through a non-solid medium. In various embodiments, the RF circuitry 1320 may include switches, filters, amplifiers, etc. to facilitate the communication with the wireless network. The RF circuitry 1320 may include a receive signal path which may include circuitry to down-convert RF signals received from the FEM circuitry 1330 and provide baseband signals to the baseband circuitry 1304. The RF circuitry 1320 may also include a transmit signal path which may include circuitry to up-convert baseband signals provided by the baseband circuitry 1304 and provide RF output signals to the FEM circuitry 1330 for transmission. In some embodiments, the receive signal path of the RF circuitry 1320 may include mixer circuitry 1322, amplifier circuitry 1324 and filter circuitry 1326. In some embodiments, the transmit signal path of the RF circuitry 1320 may include filter circuitry 1326 and mixer circuitry 1322. The RF circuitry 1320 may also include synthesizer circuitry 1328 for synthesizing a frequency for use by the mixer circuitry 1322 of the receive signal path and the transmit signal path. In some embodiments, the mixer circuitry 1322 of the receive signal path may be configured to down-convert RF signals received from the FEM circuitry 1330 based on the synthesized frequency provided by synthesizer circuitry 1328. The amplifier circuitry 1324 may be configured to amplify the down-converted signals and the filter circuitry 1326 may be a low-pass filter (LPF) or band-pass filter (BPF) configured to remove unwanted signals from the down-converted signals to generate output baseband signals. Output baseband signals may be provided to the baseband circuitry 1304 for further processing. In some embodiments, the output baseband signals may be zero-frequency baseband signals, although this is not a requirement. In some embodiments, the mixer circuitry 1322 of the receive signal path may comprise passive mixers, although the scope of the embodiments is not limited in this respect.

In some embodiments, the mixer circuitry 1322 of the transmit signal path may be configured to up-convert input baseband signals based on the synthesized frequency provided by the synthesizer circuitry 1328 to generate RF output signals for the FEM circuitry 1330. The baseband signals may be provided by the baseband circuitry 1304 and may be filtered by the filter circuitry 1326.

In some embodiments, the mixer circuitry 1322 of the receive signal path and the mixer circuitry 1322 of the transmit signal path may include two or more mixers and may be arranged for quadrature downconversion and upconversion, respectively. In some embodiments, the mixer circuitry 1322 of the receive signal path and the mixer circuitry 1322 of the transmit signal path may include two or more mixers and may be arranged for image rejection (e.g., Hartley image rejection). In some embodiments, the mixer circuitry 1322 of the receive signal path and the mixer circuitry 1322 may be arranged for direct downconversion and direct upconversion, respectively. In some embodiments, the mixer circuitry 1322 of the receive signal path and the mixer circuitry 1322 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1320 may include analog-to-digital converter (ADC) and digital-to-analog converter (DAC) circuitry and the baseband circuitry 1304 may include a digital baseband interface to communicate with the RF circuitry 1320.

In some dual-mode embodiments, a separate radio IC circuitry may be provided for processing signals for each spectrum, although the scope of the embodiments is not limited in this respect.

In some embodiments, the synthesizer circuitry 1328 may be a fractional-N synthesizer or a fractional N/N+1 synthesizer, although the scope of the embodiments is not limited in this respect as other types of frequency synthesizers may be suitable. For example, synthesizer circuitry 1328 may be a delta-sigma synthesizer, a frequency multiplier, or a synthesizer comprising a phase-locked loop with a frequency divider.

The synthesizer circuitry 1328 may be configured to synthesize an output frequency for use by the mixer circuitry 1322 of the RF circuitry 1320 based on a frequency input and a divider control input. In some embodiments, the synthesizer circuitry 1328 may be a fractional N/N+1 synthesizer.

In some embodiments, frequency input may be provided by a voltage controlled oscillator (VCO), although that is not a requirement. Divider control input may be provided by either the baseband circuitry 1304 or the application circuitry 1302 (such as an applications processor) depending on the desired output frequency. In some embodiments, a divider control input (e.g., N) may be determined from a look-up table based on a channel indicated by the application circuitry 1302.

Synthesizer circuitry 1328 of the RF circuitry 1320 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1328 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1320 may include an IQ/polar converter.

The FEM circuitry 1330 may include a receive signal path which may include circuitry configured to operate on RF signals received from one or more antennas 1332, amplify the received signals and provide the amplified versions of the received signals to the RF circuitry 1320 for further processing. The FEM circuitry 1330 may also include a transmit signal path which may include circuitry configured to amplify signals for transmission provided by the RF circuitry 1320 for transmission by one or more of the one or more antennas 1332. In various embodiments, the amplification through the transmit or receive signal paths may be done solely in the RF circuitry 1320, solely in the FEM circuitry 1330, or in both the RF circuitry 1320 and the FEM circuitry 1330.

In some embodiments, the FEM circuitry 1330 may include a TX/RX switch to switch between transmit mode and receive mode operation. The FEM circuitry 1330 may include a receive signal path and a transmit signal path. The receive signal path of the FEM circuitry 1330 may include an LNA to amplify received RF signals and provide the amplified received RF signals as an output (e.g., to the RF circuitry 1320). The transmit signal path of the FEM circuitry 1330 may include a power amplifier (PA) to amplify input RF signals (e.g., provided by the RF circuitry 1320), and one or more filters to generate RF signals for subsequent transmission (e.g., by one or more of the one or more antennas 1332).

In some embodiments, the PMC 1334 may manage power provided to the baseband circuitry 1304. In particular, the PMC 1334 may control power-source selection, voltage scaling, battery charging, or DC-to-DC conversion. The PMC 1334 may often be included when the device 1300 is capable of being powered by a battery, for example, when the device 1300 is included in a EGE. The PMC 1334 may increase the power conversion efficiency while providing desirable implementation size and heat dissipation characteristics.

FIG. 13 shows the PMC 1334 coupled only with the baseband circuitry 1304. However, in other embodiments, the PMC 1334 may be additionally or alternatively coupled with, and perform similar power management operations for, other components such as, but not limited to, the application circuitry 1302, the RF circuitry 1320, or the FEM circuitry 1330.

In some embodiments, the PMC 1334 may control, or otherwise be part of, various power saving mechanisms of the device 1300. For example, if the device 1300 is in an RRC Connected state, where it is still connected to the RAN node as it expects to receive traffic shortly, then it may enter a state known as Discontinuous Reception Mode (DRX) after a period of inactivity. During this state, the device 1300 may power down for brief intervals of time and thus save power.

If there is no data traffic activity for an extended period of time, then the device 1300 may transition off to an RRC Idle state, where it disconnects from the network and does not perform operations such as channel quality feedback, handover, etc. The device 1300 goes into a very low power state and it performs paging where again it periodically wakes up to listen to the network and then powers down again. The device 1300 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1302 and processors of the baseband circuitry 1304 may be used to execute elements of one or more instances of a protocol stack. For example, processors of the baseband circuitry 1304, alone or in combination, may be used to execute Layer 3, Layer 2, or Layer 1 functionality, while processors of the application circuitry 1302 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

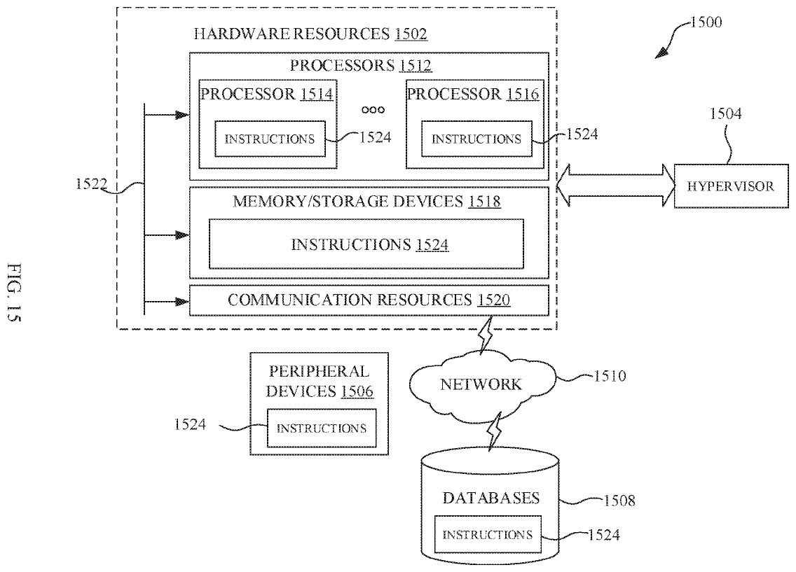

FIG. 14 illustrates example interfaces 1400 of baseband circuitry in accordance with some embodiments. As discussed above, the baseband circuitry 1304 of FIG. 13 may comprise 3G baseband processor 1306, 4G baseband processor 1308, 5G baseband processor 1310, other baseband processor(s) 1312, CPU 1314, and a memory 1318 utilized by said processors. As illustrated, each of the processors may include a respective memory interface 1402 to send/receive data to/from the memory 1318.

The baseband circuitry 1304 may further include one or more interfaces to communicatively couple to other circuitries/devices, such as a memory interface 1404 (e.g., an interface to send/receive data to/from memory external to the baseband circuitry 1304), an application circuitry interface 1406 (e.g., an interface to send/receive data to/from the application circuitry 1302 of FIG. 13), an RF circuitry interface 1408 (e.g., an interface to send/receive data to/from RF circuitry 1320 of FIG. 13), a wireless hardware connectivity interface 1410 (e.g., an interface to send/receive data to/from Near Field Communication (NFC) components, Bluetooth® components (e.g., Bluetooth® Low Energy), Wi-Fi® components, and other communication components), and a power management interface 1412 (e.g., an interface to send/receive power or control signals to/from the PMC 1334.

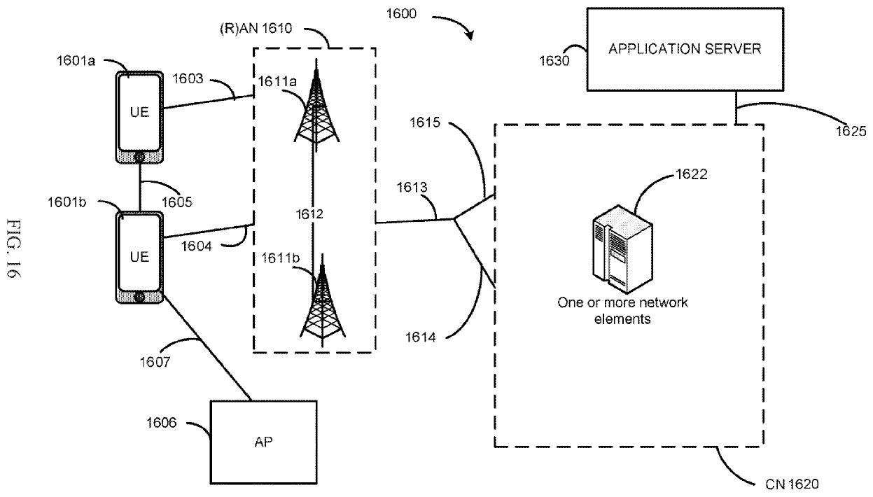

FIG. 15 is a block diagram illustrating components 1500, according to some example embodiments, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources 1502 including one or more processors 1512 (or processor cores), one or more memory/storage devices 1518, and one or more communication resources 1520, each of which may be communicatively coupled via a bus 1522. For embodiments where node virtualization (e.g., NFV) is utilized, a hypervisor 1504 may be executed to provide an execution environment for one or more network slices/sub-slices to utilize the hardware resources 1502.

The processors 1512 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1514 and a processor 1516.

The memory/storage devices 1518 may include main memory, disk storage, or any suitable combination thereof. The memory/storage devices 1518 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1520 may include interconnection or network interface components or other suitable devices to communicate with one or more peripheral devices 1506 or one or more databases 1508 via a network 1510. For example, the communication resources 1520 may include wired communication components (e.g., for coupling via a Universal Serial Bus (USB)), cellular communication components. NFC components, Bluetooth® components (e.g., Bluetooth® Low Energy), Wi-FiR components, and other communication components.

Instructions 1524 may comprise software, a program, an application, an applet, an app, or other executable code for causing at least any of the processors 1512 to perform any one or more of the methodologies discussed herein. The instructions 1524 may reside, completely or partially, within at least one of the processors 1512 (e.g., within the processor's cache memory), the memory/storage devices 1518, or any suitable combination thereof. Furthermore, any portion of the instructions 1524 may be transferred to the hardware resources 1502 from any combination of the peripheral devices 1506 or the databases 1508. Accordingly, the memory of the processors 1512, the memory/storage devices 1518, the peripheral devices 1506, and the databases 1508 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

FIG. 16 illustrates an architecture of a system 1600 of a network in accordance with some embodiments. The following description is provided for an example system 1600 that operates in conjunction with the LTE system standards and 5G or NR system standards as provided by 3GPP technical specifications. However, the example embodiments are not limited in this regard and the described embodiments may apply to other networks that benefit from the principles described herein, such as future 3GPP systems (e.g., Sixth Generation (6G)) systems), or the like.

As shown by FIG. 16, the system 1600 includes UE 1601a and UE 1601b (collectively referred to as “UEs 1601” or “UE 1601”). The UE 1601a and/or UE 1601b may correspond to the UEs described above.

In this example, UEs 1601 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

In some embodiments, any of the UEs 1601 may be IoT UEs, which may comprise a network access layer designed for low-power IoT applications utilizing short-lived UE connections. An IoT UE can utilize technologies such as M2M or MTC for exchanging data with an MTC server or device via a PLMN, ProSe or D2D communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 1601 may be configured to connect, for example, communicatively couple, with an or RAN 1610. In embodiments, the RAN 1610 may be an NG RAN or a 5G RAN, an E-UTRAN, or a legacy RAN, such as a UTRAN or GERAN. As used herein, the term “NG RAN” or the like may refer to a RAN 1610 that operates in an NR or 5G system 1600, and the term “E-UTRAN” or the like may refer to a RAN 1610 that operates in an LTE or 4G system 1600. The UEs 1601 utilize connections (or channels) 1603 and 1604, respectively, each of which comprises a physical communications interface or layer (discussed in further detail below).

In this example, the connections 1603 and 1604 are illustrated as an air interface to enable communicative coupling, and can be consistent with cellular communications protocols, such as a GSM protocol, a CDMA network protocol, a PTT protocol, a POC protocol, a UMTS protocol, a 3 GPP LTE protocol, a 5G protocol, a NR protocol, and/or any of the other communications protocols discussed herein. In embodiments, the UEs 1601 may directly exchange communication data via a ProSe interface 1605. The ProSe interface 1605 may alternatively be referred to as a SL interface 1605 and may comprise one or more logical channels, including but not limited to a PSCCH, a PSSCH, a PSDCH, and a PSBCH.

The UE 1601b is shown to be configured to access an AP 1606 (also referred to as “WLAN node 1606”. “WLAN 1606”, “WLAN Termination 1606”. “WT 1606” or the like) via connection 1607. The connection 1607 can comprise a local wireless connection, such as a connection consistent with any IEEE 802.11 protocol, wherein the AP 1606 would comprise a wireless fidelity (Wi-Fi®) router. In this example, the AP 1606 is shown to be connected to the Internet without connecting to the core network of the wireless system (described in further detail below). In various embodiments, the UE 1601b, RAN 1610, and AP 1606 may be configured to utilize LWA operation and/or LWIP operation. The LWA operation may involve the UE 1601b in RRC CONNECTED being configured by a RAN node 1611a-b to utilize radio resources of LTE and WLAN. LWIP operation may involve the UE 1601b using WLAN radio resources (e.g., connection 1607) via IPsec protocol tunneling to authenticate and encrypt packets (e.g., IP packets) sent over the connection 1607. IPsec tunneling may include encapsulating the entirety of original IP packets and adding a new packet header, thereby protecting the original header of the IP packets.

The RAN 1610 can include one or more AN nodes or RAN nodes 1611a and 1611b (collectively referred to as “RAN nodes 1611” or “RAN node 1611”) that enable the connections 1603 and 1604. As used herein, the terms “access node”, “access point” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node 1611 that operates in an NR or 5G system 1600 (for example, a gNB), and the term “E-UTRAN node” or the like may refer to a RAN node 1611 that operates in an LTE or 4G system 1600 (e.g., an eNB). According to various embodiments, the RAN nodes 1611 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the RAN nodes 1611 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by individual RAN nodes 1611; a MAC/PHY split wherein RRC, PDCP. RLC, and MAC layers are operated by the CRAN/vBBUP and the PHY layer is operated by individual RAN nodes 1611: or a “lower PHY” split wherein RRC, PDCP, RLC, MAC layers and upper portions of the PHY layer are operated by the CRAN/vBBUP and lower portions of the PHY layer are operated by individual RAN nodes 1611. This virtualized framework allows the freed-up processor cores of the RAN nodes 1611 to perform other virtualized applications. In some implementations, an individual RAN node 1611 may represent individual gNB-DUs that are connected to a gNB-CU via individual FI interfaces (not shown by FIG. 16). In these implementations, the gNB-DUs may include one or more remote radio heads or RFEMs. and the gNB-CU may be operated by a server that is located in the RAN 1610 (not shown) or by a server pool in a similar manner as the CRAN/vBBUP. Additionally or alternatively, one or more of the RAN nodes 1611 may be next generation eNBs (ng-eNBs), which are RAN nodes that provide E-UTRA user plane and control plane protocol terminations toward the UEs 1601, and are connected to a 5G core (5GC) via an NG interface.

In V2X scenarios one or more of the RAN nodes 1611 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU.” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs 1601 (VUEs 1601). The RSU may also include internal data storage circuitry to store intersection map geometry, traffic statistics, media, as well as applications/software to sense and control ongoing vehicular and pedestrian traffic. The RSU may operate on the 5.9 GHZ Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) and/or provide connectivity to one or more cellular networks to provide uplink and downlink communications. The computing device(s) and some or all of the radiofrequency circuitry of the RSU may be packaged in a weatherproof enclosure suitable for outdoor installation, and may include a network interface controller to provide a wired connection (e.g., Ethernet) to a traffic signal controller and/or a backhaul network.

Any of the RAN nodes 1611 can terminate the air interface protocol and can be the first point of contact for the UEs 1601. In some embodiments, any of the RAN nodes 1611 can fulfill various logical functions for the RAN 1610 including, but not limited to, radio network controller (RNC) functions such as radio bearer management, uplink and downlink dynamic radio resource management and data packet scheduling, and mobility management.

In embodiments, the UEs 1601 can be configured to communicate using OFDM communication signals with each other or with any of the RAN nodes 1611 over a multi carrier communication channel in accordance with various communication techniques, such as, but not limited to, an OFDMA communication technique (e.g., for downlink communications) or a SC-FDMA communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 1611 to the UEs 1601, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

According to various embodiments, the UEs 1601 and the RAN nodes 1611 communicate data (for example, transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band.

To operate in the unlicensed spectrum, the UEs 1601 and the RAN nodes 1611 may operate using LAA, eLAA, and/or feLAA mechanisms. In these implementations, the UEs 1601 and the RAN nodes 1611 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

LBT is a mechanism whereby equipment (for example, UEs 1601. RAN nodes 1611 etc.) senses a medium (for example, a channel or carrier frequency) and transmits when the medium is sensed to be idle (or when a specific channel in the medium is sensed to be unoccupied). The medium sensing operation may include CCA, which utilizes at least ED to determine the presence or absence of other signals on a channel in order to determine if a channel is occupied or clear. This LBT mechanism allows cellular/LAA networks to coexist with incumbent systems in the unlicensed spectrum and with other LAA networks. ED may include sensing RF energy across an intended transmission band for a period of time and comparing the sensed RF energy to a predefined or configured threshold.

Typically, the incumbent systems in the 5 GHz band are WLANs based on IEEE 802.11 technologies. WLAN employs a contention-based channel access mechanism, called CSMA/CA. Here, when a WLAN node (e.g., a mobile station (MS) such as UE 1601, AP 1606, or the like) intends to transmit, the WLAN node may first perform CCA before transmission. Additionally, a backoff mechanism is used to avoid collisions in situations where more than one WLAN node senses the channel as idle and transmits at the same time. The backoff mechanism may be a counter that is drawn randomly within the CWS, which is increased exponentially upon the occurrence of collision and reset to a minimum value when the transmission succeeds. The LBT mechanism designed for LAA is somewhat similar to the CSMA/CA of WLAN. In some implementations, the LBT procedure for DL or UL transmission bursts including PDSCH or PUSCH transmissions, respectively, may have an LAA contention window that is variable in length between X and Y ECCA slots, where X and Y are minimum and maximum values for the CWSs for LAA. In one example, the minimum CWS for an LAA transmission may be 9 microseconds (ps); however, the size of the CWS and a MCOT (for example, a transmission burst) may be based on governmental regulatory requirements.

The LAA mechanisms are built upon CA technologies of LTE-Advanced systems. In CA, each aggregated carrier is referred to as a CC. A CC may have a bandwidth of 1.4, 3, 5, 10, 15 or 20 MHz and a maximum of five CCs can be aggregated, and therefore, a maximum aggregated bandwidth is 100 MHz. In FDD systems, the number of aggregated carriers can be different for DL and UL, where the number of UL CCs is equal to or lower than the number of DL component carriers. In some cases, individual CCs can have a different bandwidth than other CCs. In TDD systems, the number of CCs as well as the bandwidths of each CC is usually the same for DL and UL.

CA also comprises individual serving cells to provide individual CCs. The coverage of the serving cells may differ, for example, because CCs on different frequency bands will experience different pathloss. A primary service cell or PCell may provide a PCC for both UL and DL, and may handle RRC and NAS related activities. The other serving cells are referred to as SCells, and each SCell may provide an individual SCC for both UL and DL. The SCCs may be added and removed as required, while changing the PCC may require the UE 1601 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The PDSCH carries user data and higher-layer signaling to the UEs 1601. The PDCCH carries information about the transport format and resource allocations related to the PDSCH channel, among other things. It may also inform the UEs 1601 about the transport format, resource allocation, and HARQ information related to the uplink shared channel. Typically, downlink scheduling (assigning control and shared channel resource blocks to the UE 1601b within a cell) may be performed at any of the RAN nodes 1611 based on channel quality information fed back from any of the UEs 1601. The downlink resource assignment information may be sent on the PDCCH used for (e.g., assigned to) each of the UEs 1601.

The PDCCH uses control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to six resource element groups (REGs). Each REG comprises one resource block in one OFDM symbol. The PDCCH can be transmitted using one or more CCEs, depending on the size of the downlink control information (DCI) and the channel condition. Different numbers of CCEs (e.g., aggregation level, L=1, 2, 4, 8 or 16) can be used for transmission of the PDCCH.

Some embodiments may use concepts for resource allocation for control channel information that are an extension of the above-described concepts. For example, some embodiments may utilize an EPDCCH that uses PDSCH resources for control information transmission. The EPDCCH may be transmitted using one or more ECCEs. Similar to above, each ECCE may correspond to nine sets of four physical resource elements known as an EREGs. An ECCE may have other numbers of EREGs in some situations.

The RAN nodes 1611 may be configured to communicate with one another via interface 1612. In embodiments where the system 1600 is an LTE system (e.g., when CN 1620 is an EPC), the interface 1612 may be an X2 interface 1612. The X2 interface may be defined between two or more RAN nodes 1611 (e.g., two or more eNBs and the like) that connect to EPC 1620, and/or between two eNBs connecting to EPC 1620. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a MeNB to an SeNB; information about successful in sequence delivery of PDCP PDUs to a UE 1601 from an SeNB for user data; information of PDCP PDUs that were not delivered to a UE 1601; information about a current minimum desired buffer size at the SeNB for transmitting to the UE user data; and the like. The X2-C may provide intra-LTE access mobility functionality, including context transfers from source to target eNBs, user plane transport control, etc.; load management functionality; as well as inter-cell interference coordination functionality. In embodiments where the system 1600 is a 5G or NR system (e.g., when CN 1620 is an 5GC), the interface 1612 may be an Xn interface 1612. The Xn interface is defined between two or more RAN nodes 1611 (e.g., two or more gNBs and the like) that connect to 5GC 1620, between a RAN node 1611 (e.g., a gNB) connecting to 5GC 1620 and an eNB, and/or between two eNBs connecting to 5GC 1620. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 1601 in a connected mode (e.g., CM-CONNECTED) including functionality to manage the UE mobility for connected mode between one or more RAN nodes 1611. The mobility support may include context transfer from an old (source) serving RAN node 1611 to new (target) serving RAN node 1611: and control of user plane tunnels between old (source) serving RAN node 1611 to new (target) serving RAN node 1611. A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on SCTP. The SCTP may be on top of an IP layer, and may provide the guaranteed delivery of application layer messages. In the transport IP layer, point-to-point transmission is used to deliver the signaling PDUs. In other implementations, the Xn-U protocol stack and/or the Xn-C protocol stack may be same or similar to the user plane and/or control plane protocol stack(s) shown and described herein.

The RAN 1610 is shown to be communicatively coupled to a core network—in this embodiment, core network (CN) 1620. The CN 1620 may comprise a plurality of network elements 1622, which are configured to offer various data and telecommunications services to customers/subscribers (e.g., users of UEs 1601) who are connected to the CN 1620 via the RAN 1610. The components of the CN 1620 may be implemented in one physical node or separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of the CN 1620 may be referred to as a network slice, and a logical instantiation of a portion of the CN 1620 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, the application server 1630 may be an element offering applications that use IP bearer resources with the core network (e.g., UMTS PS domain, LTE PS data services, etc.). The application server 1630 can also be configured to support one or more communication services (e.g., VoIP sessions, PTT sessions, group communication sessions, social networking services, etc.) for the UEs 1601 via the EPC 1620.

In embodiments, the CN 1620 may be a 5GC (referred to as “5GC 1620” or the like), and the RAN 1610 may be connected with the CN 1620 via an NG interface 1613. In embodiments, the NG interface 1613 may be split into two parts, an NG user plane (NG-U) interface 1614, which carries traffic data between the RAN nodes 1611 and a UPF, and the SI control plane (NG-C) interface 1615, which is a signaling interface between the RAN nodes 1611 and AMFs.

In embodiments, the CN 1620 may be a 5G CN (referred to as “5GC 1620” or the like), while in other embodiments, the CN 1620 may be an EPC). Where CN 1620 is an EPC (referred to as “EPC 1620” or the like), the RAN 1610 may be connected with the CN 1620 via an SI interface 1613. In embodiments, the SI interface 1613 may be split into two parts, an SI user plane (SI-U) interface 1614, which carries traffic data between the RAN nodes 1611 and the S-GW, and the SI-MME interface 1615, which is a signaling interface between the RAN nodes 1611 and MMEs.

### Additional Examples

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.

Example 1 is a method for a user equipment (UE), comprising: acquiring configuration information including a first configuration information for determining a configured grant (CG)/semi-persistent scheduling (SPS) configuration, wherein the first configuration information is included in a radio resource control (RRC) message: and performing a data transmission/reception via the CG/SPS configuration determined by the configuration information.

Example 2 is the method of example 1, wherein the configuration information further comprises a second configuration information for determining the CG/SPS configuration, wherein second configuration information is included in downlink control information (DCI).

Example 3 is the method of example 1, wherein the configuration information further comprises a second configuration information for determining the CG/SPS configuration, wherein the second configuration information is provided with the first configuration information via the RRC message.

Example 4 is the method of example 2 or 3, wherein the first configuration information indicates a parameter of a CG/SPS configuration index having a predetermined value, and the second configuration information indicates an occasion for the CG/SPS configuration and a plurality of serving cells on which the CG/SPS configuration is applied, and wherein the performing the data transmission/reception comprises: performing the data transmission/reception on the plurality of serving cells via carrier aggregation (CA) at the occasion for the CG/SPS configuration.

Example 5 is the method of example 4, wherein the performing the data transmission on the plurality of serving cells comprises: determining, based on an data amount, whether any of the plurality of serving cells is sufficient for the data transmission; and in response to the determination that one serving cell is sufficient for the data transmission, selecting the serving cell for the data transmission.

Example 6 is the method of example 4, wherein the performing the data reception on the plurality of serving cells comprises: detecting whether discontinuous transmission (DTX) occurs on any secondary cell among the plurality of serving cells at the occasion for the SPS configuration: and in response to the determination that the DTX is detected, skipping the data reception on the secondary cell and performing the data reception on a selected active cell among the plurality of serving cells based on a capability of the UE.

Example 7 is the method of example 2 or 3, wherein the first configuration information indicates a parameter of a CG/SPS configuration index having a predetermined value, and the second configuration information indicates a bundle of occasions for the CG/SPS configuration corresponding to a plurality of serving cells, and wherein the performing the data transmission/reception comprises: performing the data transmission/reception via the bundle of occasions for the CG/SPS configuration in a duplication manner on respective ones of the plurality of serving cells.

Example 8 is the method of example 7, wherein the performing the data transmission/reception in the duplication manner on the respective ones of the plurality of serving cells comprises: simultaneously performing the data transmission/reception on a primary cell among the plurality of serving cells and a secondary cell among the plurality of serving cells.

Example 9 is the method of example 2 or 3, wherein the first configuration information comprises a first parameter of a CG/SPS configuration index having a predetermined value, and a second parameter indicating an occasion window having predetermined numbers of selectable occasions: and the second configuration information indicates an activation of the CG/SPS configuration, and wherein the performing the data transmission/reception comprises: performing the data transmission/reception at a selected occasion within the occasion window, wherein the selected occasion is based on a capability of the UE or a time at which the data for transmission is arrived/the data for reception is detected.

Example 10 is the method of example 9, wherein the first configuration information further comprises a third parameter indicating an occasion window per periodicity, and wherein the respective selected occasions for the two adjacent occasion windows are independent from each other.

Example 11 is the method of any of examples 1-10, further comprising: determining whether at least one factor selected from a group of a transmission latency, a transmission successful rate and a radio quality meets a preset condition; and in response to the determination that the selected factor meets the preset condition, providing preference information for a configuration of the configuration information to be acquired.

Example 12 is method for a user equipment (UE), comprising: acquiring, packet association information, by an access stratum (AS) layer from an upper layer above the AS layer, wherein the packet association information indicates packets that are associated together to correspond to the same frame and a critical packet among the packets; and performing a data transmission via dedicated scheduling for the critical packet.

Example 13 is the method of example 12, further comprising: acquiring the dedicated scheduling for the critical packet, comprising: providing a dedicated scheduling request (SR) to request the dedicated scheduling for the critical packet: providing a data amount for the critical packet in a buffer status report (BSR) of a medium access control (MAC) control element (CE); and acquiring a configured grant (CG) configuration indicating a higher priority for the critical packet than the remaining packet among the packets.

Example 14 is the method of example 13, wherein the acquiring the CG configuration comprises: acquiring a downlink control information (DCI) in which the higher priority for the critical packet than the remaining packet is indicated, and wherein the performing the data transmission via dedicated scheduling for the critical packet comprises: upon receipt of the DCI, performing the data transmission only for the critical packet.

Example 15 is the method of any of examples 12 to 14, further comprising: determining whether the data transmission for the critical packet is successfully performed; in response to the determination that the data transmission for the critical packet is not successfully performed, discarding the data transmission for the remaining packet that has not been transmitted.

Example 16 is the method of any of examples 12 to 14 further comprising: determining whether the data transmission for the critical packet is successfully performed; in response to the determination that the data transmission for the critical packet is not successfully performed, performing the data transmission for the remaining packet that has been allocated with a serial number (SN) for transmission or is under ongoing transmission, in a manner that the remaining packet is indicated in a radio link control (RLC) header only without any payload for transmission.

Example 17 is the method of any of examples 12 to 14, further comprising: receiving the packets that are associated together to correspond to the same frame; determining whether the critical packet among the packets is successfully received: and in response to the determination that the critical packet is not successfully received, dropping the remaining packet among the packets in the AS layer so as not to be delivered to the upper layer.

Example 18 is the method of example 17, further comprising: providing a RLC acknowledgement (ACK) for the remaining packet as a feedback for the reception while dropping the remaining packet.

Example 19 is an apparatus for a user equipment (UE), the apparatus comprising: one or more processors configured to perform steps of the method according to any of examples 1-18.

Example 20 is a computer readable medium having computer programs stored thereon which, when executed by one or more processors, cause an apparatus to perform steps of the method according to any of examples 1-18.

Example 21 is an apparatus for a communication device, comprising means for performing steps of the method according to any of examples 1-18.

Example 22 is a computer program product comprising computer programs which, when executed by one or more processors, cause an apparatus to perform steps of the method according to any of examples 1-18.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1.-22. (canceled)

23. One or more non-transitory, computer-readable media having instructions that, when executed by one or more processors, cause a user equipment (UE) to:
acquire, from a radio resource control (RRC) message or from the RRC message and downlink control information (DCI), first configuration information and second configuration information for a configured grant (CG)/semi-persistent scheduling (SPS) configuration, wherein the first configuration information indicates a parameter of a CG/SPS configuration index having a predetermined value, and the second configuration information indicates an occasion for the CG/SPS configuration and a plurality of serving cells on which the CG/SPS configuration is to be applied; and
perform a data transmission/reception via the CG/SPS configuration.

24. The one or more non-transitory, computer-readable media of claim 23, wherein to perform the data transmission/reception the UE is to:
perform the data transmission/reception on the plurality of serving cells via carrier aggregation (CA) at the occasion for the CG/SPS configuration.

25. The one or more non-transitory, computer-readable media of claim 23, wherein to perform the data transmission/reception on the plurality of serving cells the UE is to:
determine, based on a data amount, that one serving cell of the plurality of serving cells is sufficient for the data transmission/reception; and
in response to said determination that one serving cell is sufficient for the data transmission/reception, select the one serving cell for the data transmission/reception.

26. The one or more non-transitory, computer-readable media of claim 23, wherein to perform the data transmission/reception on the plurality of serving cells the UE is to:
detect discontinuous transmission (DTX) occurs on a secondary cell of the plurality of serving cells at the occasion for the CG/SPS configuration; and
in response to detection that the DTX occurs on the secondary cell, skip data reception on the secondary cell and performing data reception on a selected active cell among the plurality of serving cells based on a capability of the UE.

27. The one or more non-transitory, computer-readable media of claim 23, wherein the second configuration information indicates a bundle of occasions for the CG/SPS configuration corresponding to the plurality of serving cells, and to perform the data transmission/reception the UE is to:
perform the data transmission/reception via the bundle of occasions for the CG/SPS configuration in a duplication manner on respective ones of the plurality of serving cells.

28. The one or more non-transitory, computer-readable media of claim 27, wherein to perform the data transmission/reception in the duplication manner on the respective ones of the plurality of serving cells the UE is to:
simultaneously perform the data transmission/reception on a primary cell among the plurality of serving cells and a secondary cell among the plurality of serving cells.

29. The one or more non-transitory, computer-readable media of claim 23, wherein the instructions, when executed, further cause the UE to:
determine a factor meets a preset condition, wherein the factor is a transmission latency, a transmission successful rate, or a radio quality; and
in response to the determination that the factor meets the preset condition, provide preference information associated with the first configuration information or the second configuration information.

30. A method of operating a base station, the method comprising:
generating first configuration information and second configuration information for a configured grant (CG)/semi-persistent scheduling (SPS) configuration, wherein the first configuration information indicates a parameter of a CG/SPS configuration index having a predetermined value, and the second configuration information indicates an occasion window having predetermined numbers of selectable occasions; and the second configuration information indicates an activation of the CG/SPS configuration; and
transmitting, to a user equipment (UE), the first and second configuration information in a radio resource control (RRC) message or in the RRC message and downlink control information (DCI).

31. The method of claim 30, further comprising:
performing data transmission/reception at a selected occasion within the occasion window, wherein the selected occasion is based on a capability of the UE or a time at which data arrives or is detected.

32. The method of claim 31, wherein the first configuration information further comprises a third parameter indicating an occasion window per periodicity, and wherein respective selected occasions for two adjacent occasion windows are independent from each other.

33. The method of claim 30, further comprising:
receiving, from the UE, preference information associated with the first configuration information or the second configuration information.

34. A user equipment (UE) comprising:
memory to store data; and
processing circuitry, coupled with the memory, the processing circuitry to:
acquire, packet association information, by an access stratum (AS) layer from an upper layer above the AS layer, wherein the packet association information is to indicate a plurality of packets that are associated together to correspond to a same frame and a critical packet among the plurality of packets; and
transmit the data via dedicated scheduling for the critical packet.

35. The UE of claim 34, wherein the processing circuitry is further to:
acquire the dedicated scheduling for the critical packet.

36. The UE of claim 35, wherein to acquire the dedicated scheduling, the processing circuitry is to:
provide a dedicated scheduling request (SR) to request the dedicated scheduling for the critical packet;
provide a data amount for the critical packet in a buffer status report (BSR) of a medium access control (MAC) control element (CE); and
acquire a configured grant (CG) configuration that is to indicate a higher priority for the critical packet than other packets of the plurality of packets.

37. The UE of claim 36, wherein: to acquire the CG configuration, the processing circuitry is to:
acquire a downlink control information (DCI) in which the higher priority for the critical packet than the other packets is indicated.

38. The UE of claim 37, wherein to transmit the data via dedicated scheduling for the critical packet, the processing circuitry is to:
upon receipt of the DCI, transmit the data only for the critical packet.

39. The UE of claim 34, wherein the processing circuitry is further to:
determine transmission of data for the critical packet is not successfully performed; and
in response to the determination that the transmission of the data for the critical packet is not successfully performed, discard data for another packet that has not been transmitted.

40. The UE of claim 34, wherein the processing circuitry is further to:
determine transmission of data for the critical packet is not successfully performed; and
in response to the determination that the transmission of the data for the critical packet is not successfully performed, transmit data for another packet that has been allocated with a serial number (SN) for transmission or is under ongoing transmission, in a manner that the other packet is indicated in a radio link control (RLC) header only without any payload for transmission.

41. The UE of claim 34, wherein the processing circuitry is further to:
receive the packets that are associated together to correspond to the same frame;
determine the critical packet among the packets is not successfully received; and
in response to the determination that the critical packet is not successfully received, drop another packet among the packets in the AS layer so as not to be delivered to the upper layer.

42. The UE of claim 41, wherein the processing circuitry is further to:
provide a radio link control (RLC) acknowledgement (ACK) for the other packet as a feedback for reception while dropping the other packet.
